(19) United States
(12) Patent Application Publication
(10) Pub. No.: US 2015/0049101 A1
(43) Pub. Date: Feb. 19, 2015

(54) DISPLAY ADAPTATION SYSTEM FOR MIPI DISPLAY SERIAL INTERFACE APPLICATIONS

(71) Applicants: NOBUYUKI SUZUKI, Portland, OR (US); Vijayakumar Balakrishnan, Bangalore (IN); Rajesh Sapra, Hillsboro, OR (US)

(72) Inventors: NOBUYUKI SUZUKI, Portland, OR (US); Vijayakumar Balakrishnan, Bangalore (IN); Rajesh Sapra, Hillsboro, OR (US)

(21) Appl. No.: 14/462,087

(22) Filed: Aug. 18, 2014

Related U.S. Application Data
(60) Provisional application No. 61/866,814, filed on Aug. 16, 2013.

(51) Int. Cl. G09G 5/00

(52) U.S. Cl. CPC G09G 5/006; G09G 2370/12
USPC 345/520

(57) ABSTRACT

Apparatus, methods, and systems are herein described for requesting Device Descriptor Block information from a display device. Further, storing the Device Descriptor Block information within processor memory. Advantageously, adaptation may be performed based on the stored Device Descriptor Block information to configure a display controller according to parameter settings in the Device Descriptor Block.

### PRIORITY

This disclosure claims priority to U.S. Provisional Patent Application No. 61/866,814 filed Aug. 16, 2013 entitled “Adaptation System for MIPI Applications” herein incorporated by reference in its entirety.

### FIELD

This disclosure pertains to computing systems, and in particular (but not exclusively) to techniques for performing adaptation for MIPI applications.

### BRIEF DESCRIPTION OF THE DRAWINGS

FIG. 1 is a diagram illustrating an embodiment of a block diagram for a computing system including a multicore processor.

FIG. 2 is a diagram illustrating an embodiment of a low power computing platform.

FIG. 3 is a diagram illustrating an embodiment of a low power data transmission platform.

FIG. 4 illustrates a display system consistent with the present disclosure.

FIG. 5 illustrates a read request and response sequence between the display controller and the display device for retrieving Device Descriptor Block (DDB) information.

FIG. 6 illustrates DDB parameters for a display device.

FIG. 7 illustrates a processor and display controller of a display system consistent with the present disclosure.

FIG. 8 illustrates a synchronous display architecture consistent with the present disclosure.

FIG. 9 illustrates an isochronous display architecture consistent with the present disclosure.

FIG. 10 illustrates a first embodiment of a set of fields for retaining DDB parameter information.

FIG. 11 illustrates a second embodiment of a set of fields for retaining DDB parameter information.

FIG. 12 illustrates a third embodiment of a set of fields for retaining DDB parameter information.

FIG. 13 is a flowchart of a method for performing adaptation in a display system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etcetera in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that may perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the disclosure described herein.

Note that the apparatus, methods, and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

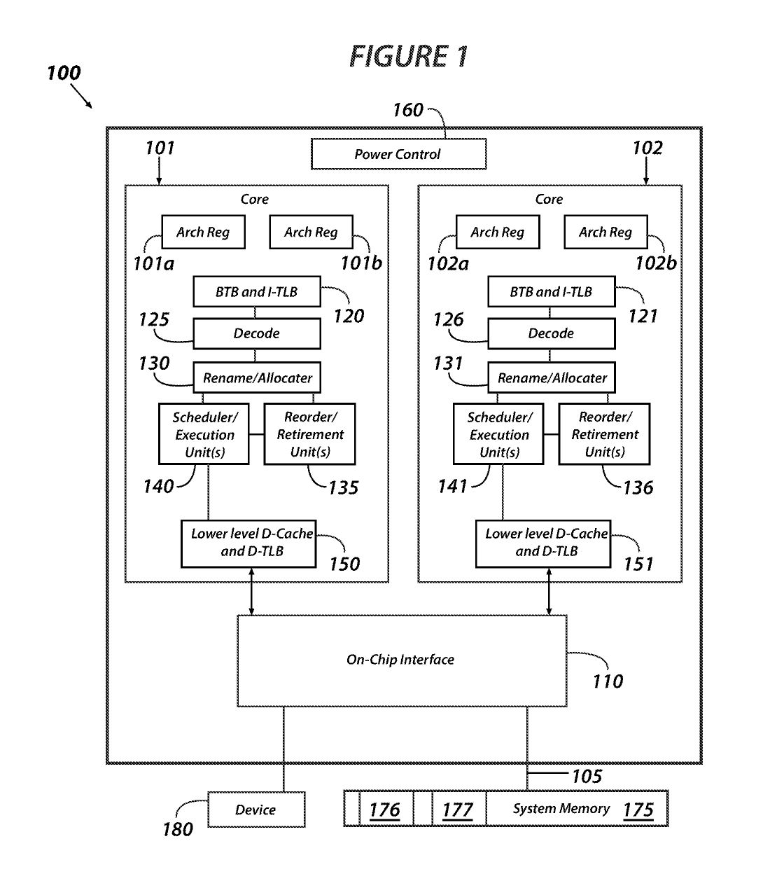

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 110 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etcetera in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

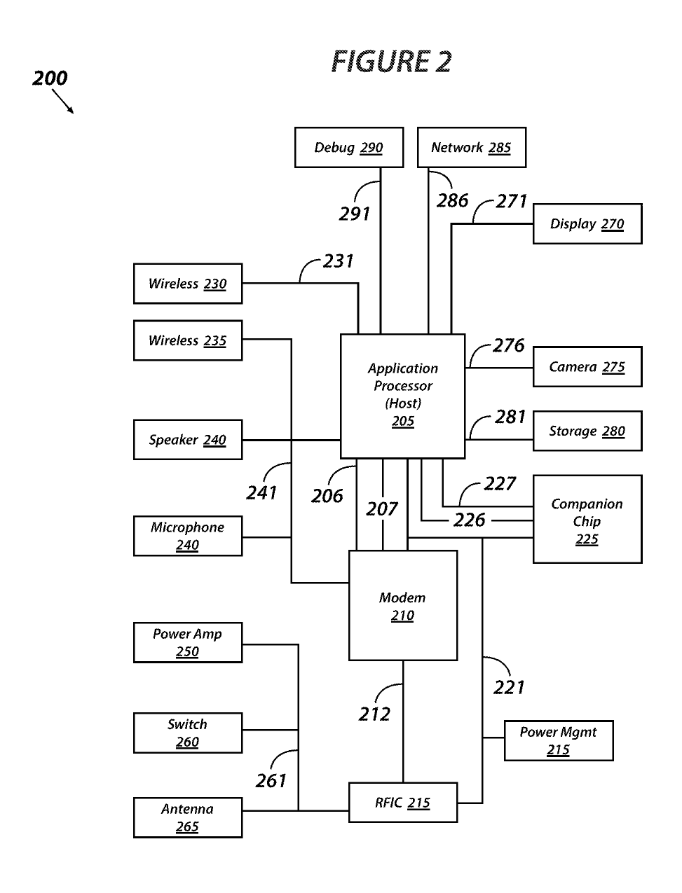

Referring to FIG. 2, an embodiment of a low power computing platform is depicted. In one embodiment, low power computing platform 200 includes a user endpoint, such as a phone, smartphone, tablet, ultraportable notebook, a notebook, a desktop, a server, a transmitting device, a receiving device, or any other known or available computing platform. The illustrated platform depicts a number of different interconnects to couple multiple different devices. Exemplary discussion of these interconnect are provided below to provide options on implementation and inclusion. However, a low power platform 200 is not required to include or implement the depicted interconnects or devices. Furthermore, other devices and interconnect structures that are not specifically shown may be included.

Starting at the center of the diagram, platform 200 includes application processor 200. Often this includes a low power processor, which may be a version of a processor configuration described herein or known in the industry. As one example, processor 200 is implemented as a system on a chip (SoC). As a specific illustrative example, processor 200 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor.

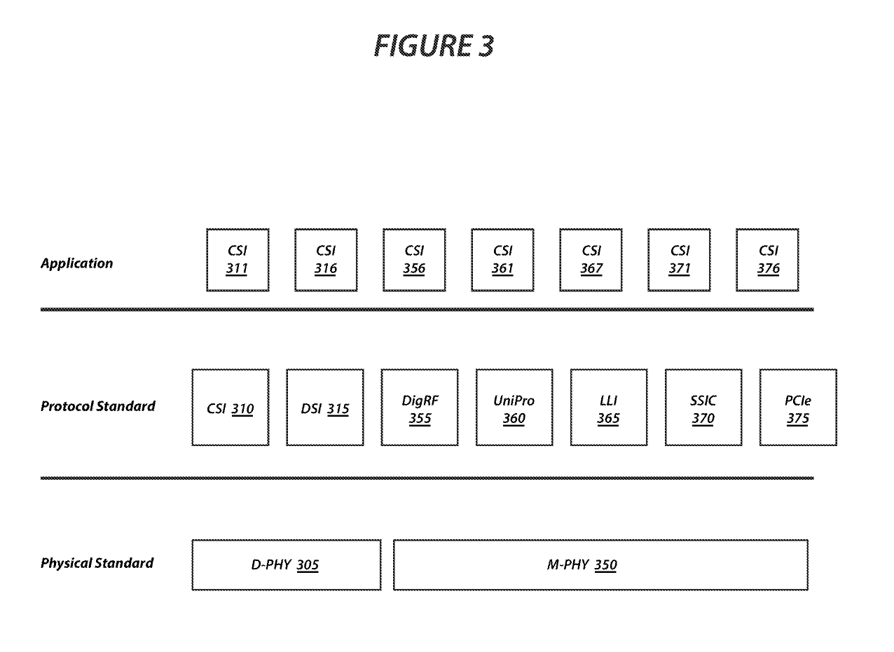

FIG. 3 is a diagram illustrating an embodiment of a low power data transmission platform. As shown, an application layer, protocol standard layer, and physical standard layer are displayed in the figure. In particular, the application layer provides various instances of a camera serial interface (CSI)—311, 316, 356, 361, 367, 371, and 376. Notably, CSI may include a unidirectional differential serial interface to transmit data and clock signals.

The protocol standard layer includes another instance of a CSI interface 310 and a Digital Serial Interface (DSI) 315. DSI may define a protocol between a host processor and a peripheral device using a D-PHY physical interface. In addition, the protocol standard layer includes a DigRF interface 355, UniPro interface 360, Low Latency Interface (LLI) 365, SuperSpeed Inter-Chip (SSIC) interface 370, and Peripheral Component Interconnect Express (PCIe) 375 interface.

Lastly, the physical standard layer provides a D-PHY 305 sub-layer. It may be understood by one having ordinary skill in the art that D-PHY includes a physical layer solution upon which MIPI camera interfaces, display serial interfaces, and general purpose high-speed/low-power interfaces are based. In addition, the physical standard layer includes a M-PHY sub-layer 350 which is the successor of D-PHY, requiring less pins and providing more bandwidth per pin (pair) with improved power efficiency.

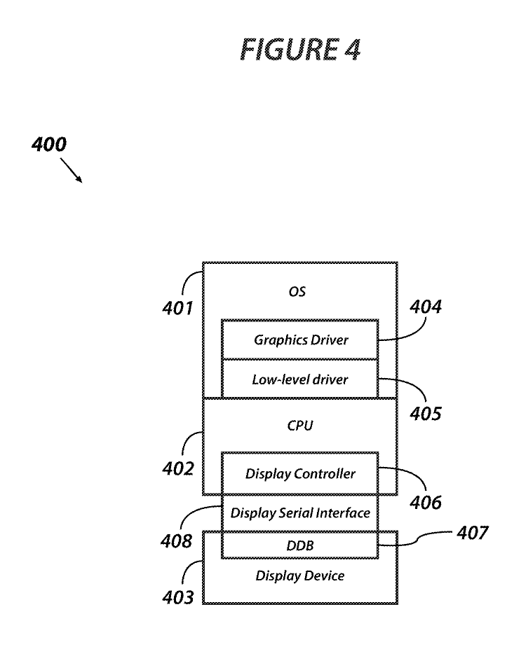

FIG. 4 illustrates a display system 400 consistent with the present disclosure. In particular, FIG. 4 illustrates a display system 400 comprising a CPU 402 which includes a display controller 406; an operating system (OS) 401 which has a graphics driver 404 and a low-level driver 405; and a peripheral display device 403 which includes a Device Descriptor Block (DDB) 407. In some embodiments, CPU 402 is a SoC device which is coupled to the display device 403 via a Display Serial Interface 408. OS 401 may include any suitable operating system such as, but not limited to, Unified Extensible Firmware Interface, Windows, Linux, or Android.

In some implementations, DDB 407 is a MIPI standard service which is utilized to implement display adaptation. In some embodiments, as shown, the display device 403 contains the display configuration properties in the DDB 407. In the present disclosure, the OS 401, CPU 402, and display device 403 cooperate together to decrease the overall costs and complexity of the adaption process for display systems.

Graphics driver 404 may perform high-level graphics activity for the display system such as overlying windows, icons, etcetera whereas low-level driver 405 may manage access to the display device 403. In some embodiments, managing access to the display device 403 includes performing an adaptation process to “adapt” the display. “Adaptation” in this disclosure includes a process of configuring the display controller to properly control a display device 403 such that the graphics information from the OS 401 is properly displayed for optimal performance on a display device 403. Adaptation may be performed automatically once the display device is electrically coupled to the processor.

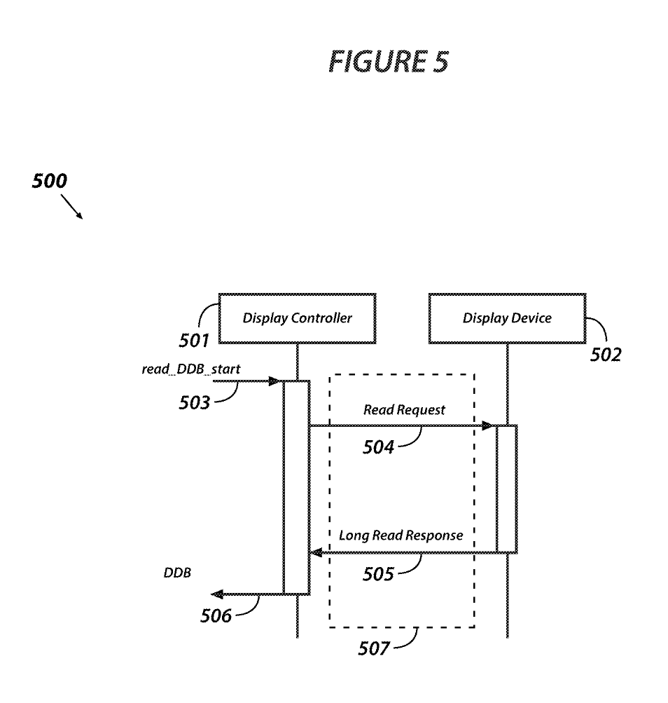

In some implementations, CPU 402 obtains a copy of the DDB 407 from the display device 403 to configure the display controller 406, by updating the registers therein, according to the DDB 407 parameter data. The process to which CPU 402 obtains a copy of the DDB 407 is described in more detail in the description for FIG. 5.

FIG. 5 illustrates a read request and response sequence between the display controller 501 and the display device 502 for retrieving Device Descriptor Block (DDB) information. In some implementations, during display device initialization, the low-level driver automatically reads the DDB from the display device. The process of reading the DDB from the display device may be initiated by a MIPI Display Command Set instruction “read DDB start” 503 that is packetized by a MIPI DSI Read Request Packet 504.

In some implementations, a low-level driver initiates the request such that a MIPI DSI Read Request Packet 504 is transmitted by the display controller 501 to the display device 502. In response, the display device 502 sends a copy of the DDB to the display controller 501 via a DSI Bus Turn Around instruction by way of the Display Serial Interface 507. In some embodiments, the copy of the DDB is embedded in a MIPI DSI Long Read Response Packet 505 which may be received by the low-level driver. The copy of the DDB is stored in memory and may be subsequently used to configure the display controller 501 by updating the registers therein.

It should be understood by those having ordinary skill in the art that a DSI Bus Turn Around is a protocol in MIPI D-PHY which changes the bus direction to allow information to be transferred from a display device 502 to a display controller 501. Furthermore, in MIPI, data sent from a peripheral device (e.g., display, camera, etc.) may be in a Long Read Response format.

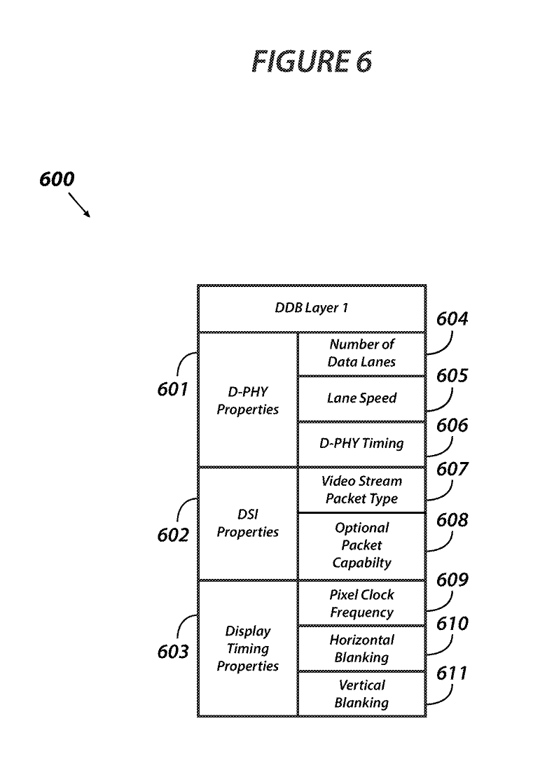

FIG. 6 illustrates DDB parameters 600 for a display device. The DDB parameters 600 shown are divided into three classes. The first class includes D-PHY parameters 601. The D-PHY parameters include the number of data lanes 604, lane speed 605, and D-PHY timing information 606. Next, as set of DSI parameters 602 includes video stream packet type 607 and optional packet capability 608. Lastly, a set of display timing parameters 603 include pixel clock frequency 609, horizontal blanking 610, and vertical blanking 611. In some implementations, the data size for each of the aforementioned set of parameters is approximately 35 bytes (D-PHY), 18 bytes (DSI), and 60 bytes (Display Timing). However, the data sizes are exemplary and the present disclosure is not limited thereto.

In some implementations, only the parameters of a single set of parameters are needed to configure the display controller for adaptation. As such, a device system consistent with the present disclosure may only require the parameter sets of D-PHY, DSI, or Display Timing to employ the adaptation process.

For example, to achieve adaptation, the display controller may be configured with the D-PHY set of parameters. Thus, in some embodiments, the display controller registers (not shown) may be updated with the number of the applied PHY layer data lane counts, the maximum and minimum data rates for each data lane, and the timing variables—T(CLK-TERM-EN), T(CLK-SETTLE), T(D-TERM-EN), T(HS-SETTLE), and T(LPX).

The DSI set of parameters used for adaptation may include the supported display architecture type and the supported video stream type. The Display set of parameters used for adaptation includes the address of the display local frame memory, the display video mode timing (e.g., pixel clock frequency, the horizontal and vertical blanking, and the addressable display area), the display active area physical size, and the display color coordinates.

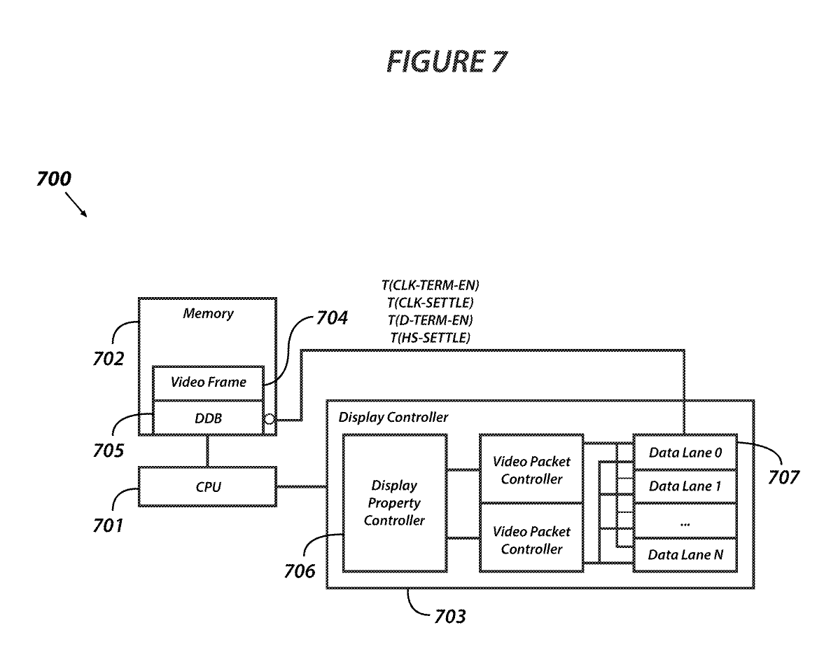

FIG. 7 illustrates a display system 700 consistent with the present disclosure. In some embodiments, display system 700 includes a CPU 701, CPU memory 702, and a display controller 703. Information may be transferred back and forth between the SoC and a display device via a communications link 707. Communication link 707 may include a first differential pair to transmit data symbols, a second differential pair to transmit a first clock signal, a third differential pair to receive data symbols, and a fourth differential pair to receive a second clock signal. Most notably, the retrieved copy of the DDB 705 is stored in CPU memory 702 and is used to configure the display controller 703 according to the parameters read.

In some implementations, when achieving adaptation by configuring the display controller 703 (i.e., the display property controller 706), the device system 700 initially sets the applied physical layer and the applied number of the data lanes according to the parameter information obtained from the copy of the DDB 705. Next, in some embodiments, the device system 700 configures CPU D-PHY T(CLK-PREPARE), T(CLK-ZERO), T(HS-PREPARE), and (T(HS-ZERO) parameters according to the T(CLK-TERM-EN), T(CLK-SETTLE), T(D-TERM-EN) and T(HS-SETTLE) DDB parameters to enable D-PHY High Speed Data Transmission communication between the CPU and the connected display device.

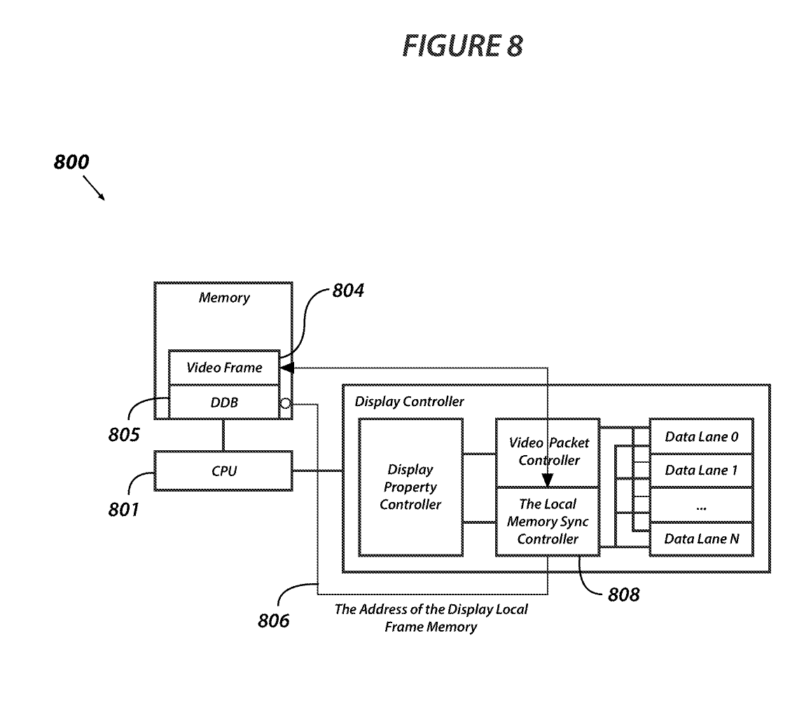

FIG. 8 illustrates a synchronous display architecture (smart display system) 800 consistent with the present disclosure. Smart display system 800 typically does not perform video refresh but includes a low frame memory that constantly shows an image. Smart display system 800 may perform adaptation by configuring the display controller 806 according to the DSI set of parameters obtained from the copy of DDB 805.

Smart display system 800 may be configured for the CPU 801 to enable the local memory sync controller 808 for a particular display application. The display device's local frame memory (not shown) is mapped (via the local memory sync controller 808) to the video frame memory 804 when the display content update is initiated. Once the video data is mapped to the display device's local frame memory, the display device can display the image.

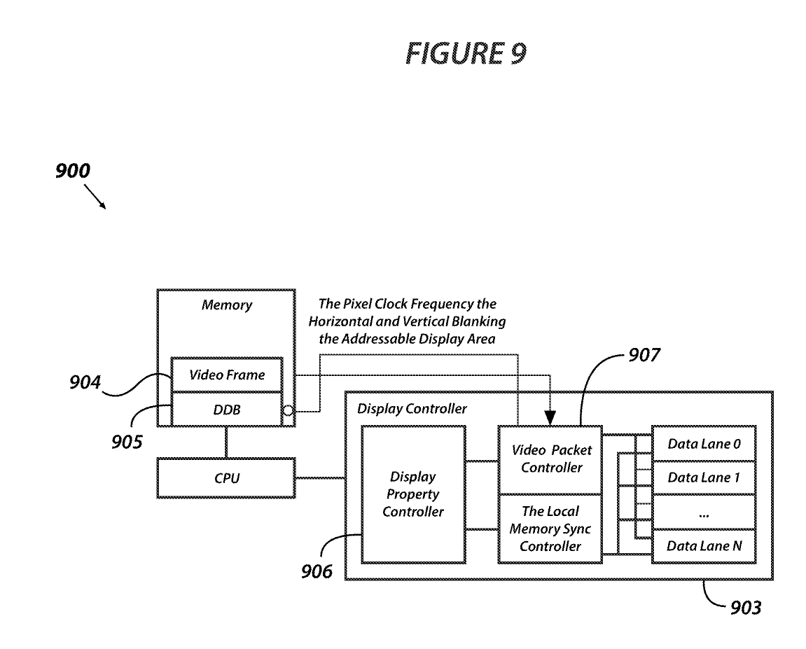

FIG. 9 illustrates an isochronous display architecture (dummy display system) 900 consistent with the present disclosure. Dummy display architecture system 900 typically employs video refresh but does not utilize the display device's local frame buffer. The dummy display system 900 may perform adaptation for the display controller 906 by configuring the display controller 906 video timing parameters according to the set of Display timing parameters obtained from the copy of DDB 905.

For dummy display systems 900 video data is transferred from the video frame memory 904 to the video packet controller 907 of the display controller 903 according to some embodiments of the present disclosure. The dummy display system 900 configures the display controller video timing according to the obtained DDB parameters such as the pixel clock frequency, horizontal and vertical blanking, and the addressable display area.

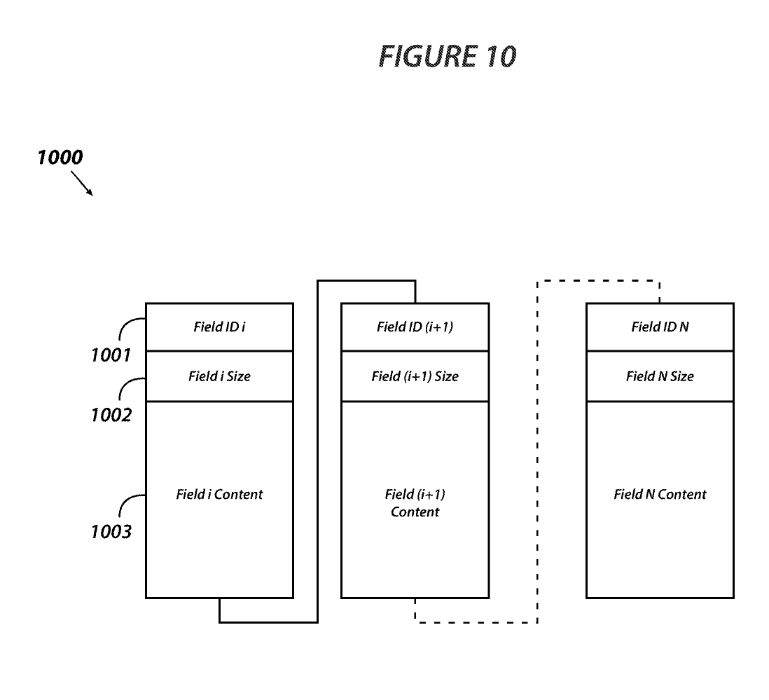

FIG. 10 illustrates a first embodiment of a set of fields 1000 for retaining DDB parameter information. Data structure 1000 includes sub-fields for Field ID “i” 1001, Field Size 1002, and Field “i” Content 1003. In some embodiments, the field size may be used to determine the next field's start address. Notably, when a copy of DDB is read to access Field ID “k” information, each Field ID and Field Size are read until Field ID “k” is accessed.

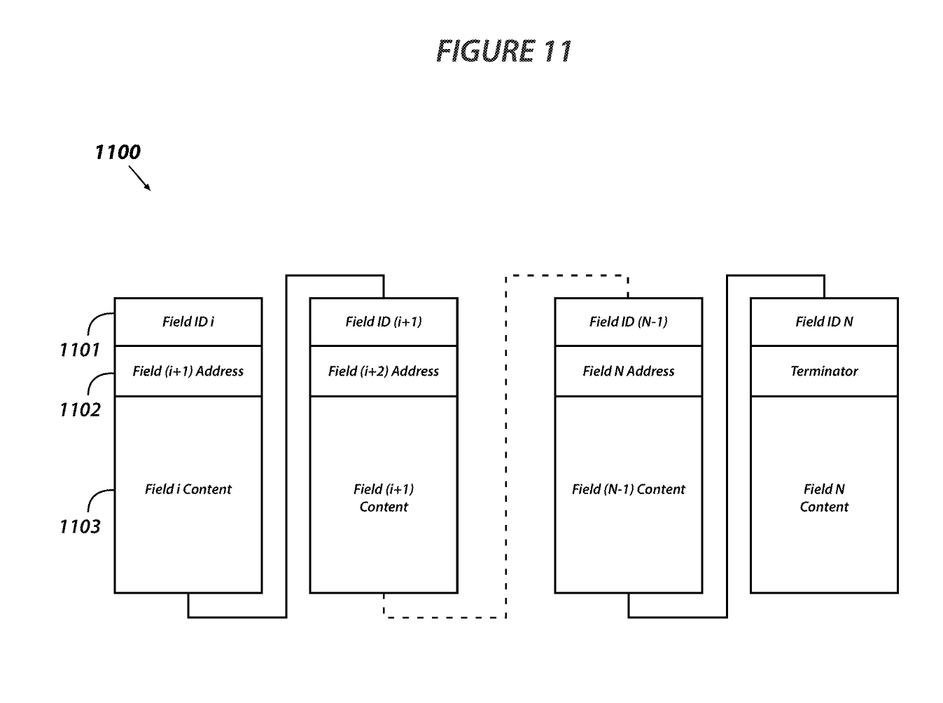

FIG. 11 illustrates a second embodiment of a set of fields 1100 for retaining DDB parameter information. Data structure 1100 includes a Field ID “i” 1101, Field (i+1) Address 1102, and Field “i” Content 1103 sub-field. The Field (i+1) Address sub-field 1102 may be used to access the next field.

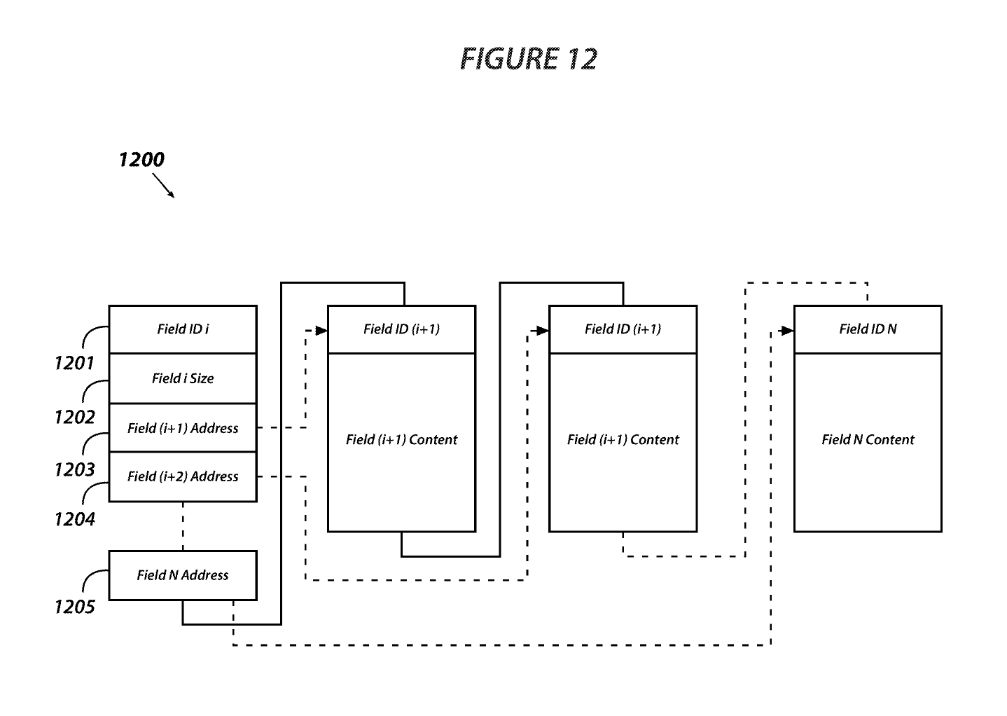

FIG. 12 illustrates a third embodiment of a set of fields 1200 for retaining DDB parameter information. The first field in the set of data structures includes a single field for retaining the field address of each field in the set. In some embodiments, when the (copy of) DDB information is read to access Field ID “k” information, the table is read to recognize the Field “k” start address. Once the address is recognized, the Field ID “k” information is directly accessed.

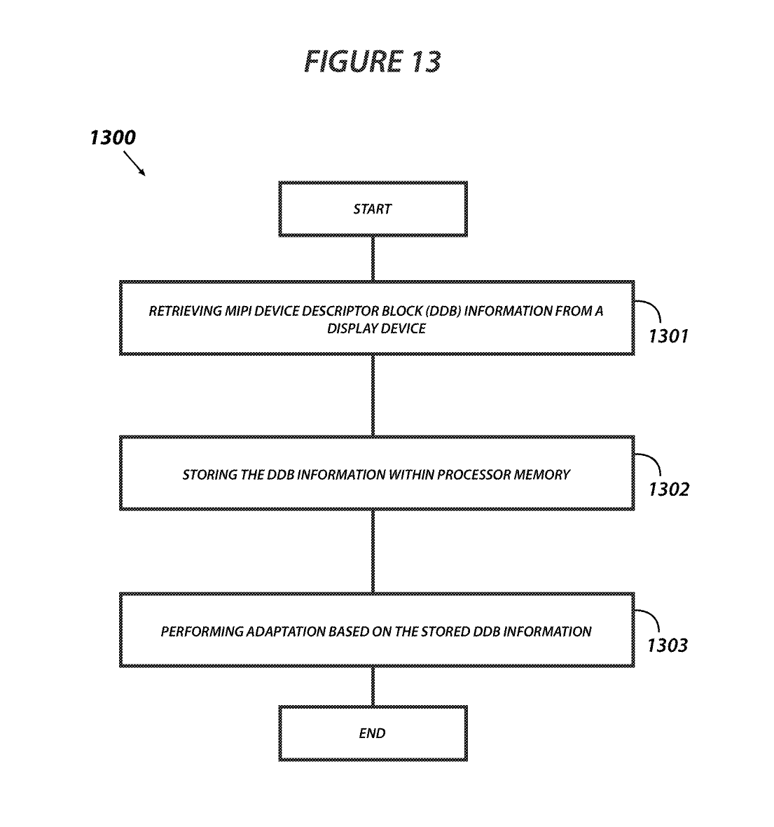

FIG. 13 is a flowchart 1300 of a method for performing adaptation in a display system. Flowchart 1300 begins with block 1301—retrieving MIPI Device Descriptor Block (DDB) information from a display device. As described above, a low-level driver may request a copy of the DDB from the display driver. A display controller component of a processor may send a packetized request and the copy of the DDB may be sent by the display device of a DSI interconnect.

Block 1302 provides for storing the copy of the DDB within processor memory. Next, performing adaptation based on the stored DDB information (block 1303). In some implementations, adaptation includes configuring the display controller according to the parameter settings in the DDB. Advantageously, once the display controller is configured according to the adaptation process, video data may be processed very efficiently as the complexity of the low-level driver adaptation and validation is relaxed.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as may be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase “to” or “configured to,” in one embodiment, refers to arranging, putting together, manufacturing, offering to sell, importing and/or designing an apparatus, hardware, logic, or element to perform a designated or determined task. In this example, an apparatus or element thereof that is not operating is still “configured to” perform a designated task if it is designed, coupled, and/or interconnected to perform said designated task. As a purely illustrative example, a logic gate may provide a 0 or a 1 during operation. But a logic gate “configured to” provide an enable signal to a clock does not include every potential logic gate that may provide a 1 or 0. Instead, the logic gate is one coupled in some manner that during operation the 1 or 0 output is to enable the clock. Note once again that use of the term “configured to” does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases “capable of/to,” and or “operable to,” in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other foam of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions may be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in some embodiments” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A device, comprising:
a display controller coupled to the processor though a link, wherein the link is to include a first differential pair to transmit data symbols, a second differential pair to transmit a first clock signal, a third differential pair to receive data symbols, and a fourth differential pair to receive a second clock signal and wherein the display controller is to be configured, during an adaptation process, according to at least one parameter of a Device Descriptor Block (DDB).

2. The device of claim 1, wherein the link is a MIPI Display Serial Interface link.

3. The device of claim 1, wherein the processor includes memory which is to store a copy of the DDB therein.

4. A device, comprising:
a processor;
memory coupled to the processor, the memory is to store Device Descriptor Block (DDB) information; and
a display controller coupled to the processor through a link, the display controller is to be configured according to at least one parameter of the DDB information during an adaptation process.

5. The device of claim 4, wherein the link includes, but is not limited to, a lane comprising a first differential pair to transmit data symbols and a second differential pair to transmit a clock signal.

6. The device of claim 4, wherein the link is based on a MIPI specification and the DDB is compliant with the MIPI specification.

7. The device of claim 4, wherein the MIPI specification includes a D-PHY specification.

8. The device of claim 1, wherein the display controller includes a video packet controller and a local memory sync controller.

9. The device of claim 1, wherein the display controller includes registers which are updated with the at least one parameter of the DDB information during the adaptation process.

10. The device of claim 1, wherein the memory includes a set of fields which include Field ID, Field Size, and Field Content sub-fields.

11. The device of claim 1, wherein the memory includes a set of fields which include Field ID, Field Address, and Field Content sub-fields.

12. The device of claim 1, wherein the memory includes a set of fields which includes a single field which stores the address of each field within the set of fields.

13. A method, comprising:
requesting MIPI Device Descriptor Block (DDB) information from a display device;
storing the DDB information in a memory component of a processor; and
configuring a display controller with at least a portion of the DDB information to perform adaptation.

14. The method of claim 13, wherein the adaptation includes configuring a display controller such that the graphics information is properly displayed on the display device.

15. The method of claim 13 further comprising sending video data from a video frame portion in the processor memory to a local memory sync controller component in the display controller and sending the video data from the local memory sync controller to a local frame memory within the display device.

16. The method of claim 15 further comprising displaying video content by the display device based on the video data stored in the local frame memory.

17. The method of claim 13 further comprising sending video data from a video frame portion in the processor memory to a video packet controller and sending the video data from the video packet controller to a local frame memory within the display device.

18. The method of claim 17 further comprising displaying video content by the display device based on the video data stored in the local frame memory.

19. The method of claim 13, wherein the DDB information includes at least one of a number of data lanes, lane speed, D-PHY timing, video stream packet type, packet capability, pixel clock frequency, horizontal blanking, and vertical blanking parameters.

20. The method of claim 13, wherein the adaptation is performed automatically once the display device is electrically coupled to the processor.

21. A computer readable medium including code, when executed, to cause a machine to:
retrieve MIPI Device Descriptor Block (DDB) information from a display device;
store the DDB information within processor memory; and
perform adaptation based on the stored DDB information.

22. The computer readable medium of claim 21 further comprising code to:
employ a low-level driver to request the DDB information.

23. The computer readable medium of claim 22, wherein to request the DDB information includes sending a MIP DSI Read Request Packet from the display controller to the display device.

24. The computer readable medium of claim 21 further comprising code to:
send the DDB information in the form of a Long Read Response packet.

25. The computer readable medium of claim 21, wherein to perform adaptation includes configuring a display controller to control a display device such that the graphics information is properly displayed on the display device.

26. The computer readable medium of claim 25, wherein configuring the display controller includes applying a single set of parameters of a DDB property to registers in the display controller.

27. The computer readable medium of claim 26, wherein the DDB property is at least one of a MIPI PHY, MIPI DSI, or MIPI Display set of parameters.

28. A system, comprising:
a touch-screen display device, the touch-screen display device having a MIPI Device Descriptor Block (DDB); and
a processor, the processor having a display controller and processor memory;
wherein the processor memory is to store a copy of the DDB; and
wherein the copy of the DDB is to be used to configure the display controller for adaptation.

29. The system of claim of claim 28 further comprising a storage component to store an operating system software wherein the operating system software includes a low-level driver which to request a copy of the DDB from the display device.

30. The system of claim 28, wherein the copy of the DDB includes at least one of a number of data lanes, lane speed, D-PHY timing, video stream packet type, packet capability, pixel clock frequency, horizontal blanking, and vertical blanking parameter information.

31. The system of claim 28, wherein the processor is coupled to the display device by a Display Serial Interface.

32. The system of claim 28, wherein the touch-screen display device is a component of at least one of a smart-phone, feature phone, notebook, tablet, or all-in-one touch screen display.
